(19) United States
(12) Patent Application Publication
(10) Pub. No.: US 2017/0361407 A1
(43) Pub. Date: Dec. 21, 2017

(54) MULTI-AXIS NUT RUNNER APPARATUS AND METHOD OF OPERATING THE MULTI-AXIS NUT RUNNER APPARATUS

(71) Applicant: HYUNDAI MOTOR COMPANY, Seoul (KR)

(72) Inventors: Dong Ho KWAK, Ulsan (KR); Su Young KIM, Ulsan (KR); Se Hoon HAM, Ulsan (KR); Yong Tae KIM, Ulsan (KR)

(21) Appl. No.: 15/289,559

(22) Filed: Oct. 10, 2016

(30) Foreign Application Priority Data
Jun. 20, 2016 (KR) 10-2016-0076529

(51) Int. Cl. B23P 19/04

(52) U.S. Cl. CPC B23P 19/04; B23P 2700/50

(57) ABSTRACT

A multi-axis nut runner apparatus includes a base frame, a mounting frame mounted on the base frame to be vertically movable, a pallet having an object disposed thereon and transferred along a transfer rail, and a variable device installed on the mounting frame and partitioned into a plurality of regions depending on a size of the object to thereby be fastened.

### CROSS-REFERENCE TO RELATED APPLICATION

This application is claims the benefit of priority to Korean Patent Application No. 10-2016-0076529, filed on Jun. 20, 2016 with the Korean Intellectual Property Office, the disclosure of which is incorporated herein in its entirety by reference.

### TECHNICAL FIELD

The present disclosure relates to a multi-axis nut runner apparatus and a method of operating the multi-axis nut runner apparatus, and more particularly, to a multi-axis nut runner apparatus capable of changing a fastening position depending on objects having various sizes, and a method of operating the multi-axis nut runner apparatus.

### BACKGROUND

A key point of a vehicle manufacturing factory is to assemble parts of a vehicle or a function unit moved along a line, and to tighten bolts and nuts to complete the vehicle. Since examples of work, or work content, include a bolt fastening work requiring a torque, a fitting work, an attaching work, piping, wiring, and connecting works, and the like, the work is performed depending on abilities and determination of an assembler.

In addition, as a fastening tool used for a part assembly by screwing parts such as a bolt or a nut, a screw, and the like, a screw driver may be used for a piece of work. Also, an impact wrench, a nut runner, and the like are used for bolt and nut work, and an electric servo-type nut runner is used for a portion requiring stable tightening torque.

Such a nut runner has a problem in that it requires an apparatus configuration capable of accommodating different engine heights between models. Further, since an apparatus configuration capable of accommodating different bolt fastening pitches between the models is required, and shapes and arrangements of equipment are different depending on a fastening position and a model difference, the nut runner needs to be remodeled at the time of adding a new model, which causes a problem that it is difficult to sufficiently secure, or conduct, a test operation.

### SUMMARY

The present disclosure has been made to solve the above-mentioned problems occurring in the prior art while advantages achieved by the prior art are maintained intact.

An aspect of the present disclosure provides a flexible multi-axis nut runner apparatus which does not require altering facilities in spite of standardization of the facilities according to a change of engine sizes, and a difference of part shapes between models, and a method of operating the multi-axis nut runner apparatus.

However, objects of the present disclosure are not limited to the objects described above, and other objects that are not described above may be clearly understood by those skilled in the art from the following description.

According to an exemplary embodiment of the present disclosure, a multi-axis nut runner apparatus includes: a base frame; a mounting frame mounted on the base frame to be vertically movable; a pallet having an object disposed thereon and transferred along a transfer rail; and a variable device installed on the mounting frame and partitioned into a plurality of regions depending on a size of the object to thereby be fastened.

The variable device may include a plurality of runners so as to be fastened to the object in the plurality of partitioned regions.

The plurality of runners may include a first runner, a second runner, a third runner, and a fourth runner that each partition a portion of the plurality of regions to thereby be fastened thereto.

The plurality of runners may include: a first cylinder moved in a direction crossing a movement direction of the object; a second cylinder mounted on the first cylinder and moved in a direction crossing the first cylinder; and a third cylinder mounted on the second cylinder and fastened to the object.

The first cylinder may be installed with a linear rail allowing the second cylinder to be moved in the direction crossing the first cylinder.

The first cylinder may include a ball screw to axially move the first cylinder.

The multi-axis nut runner apparatus may further include a flexible column mounted on the mounting frame so as to maintain a predetermined interval between the variable device and the object.

The flexible column may include a fixing pin provided to secure a position of the object.

The flexible column may have a support frame formed to fix the fixing pin, and include an electric cylinder vertically moving the support frame.

Specific matters of other exemplary embodiments will be included in a detailed description and the accompanying drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a perspective view illustrating a multi-axis nut runner apparatus according to embodiments of the present disclosure.

FIG. 2 is a view illustrating a variable device of FIG. 1.

FIG. 3 is a cross-sectional view taken along plane A-A of FIG. 2.

FIGS. 4 and 5A and 5B are views illustrating a multi-axis nut runner apparatus and a fixing pin according to embodiments of the present disclosure.

FIGS. 6A to 6H are perspective views illustrating an operation of a multi-axis nut runner apparatus according to embodiments of the present disclosure.

FIG. 7 is a plan view illustrating objects having different sizes stacked on a pallet according to embodiments of the present disclosure.

FIG. 8 is a flowchart illustrating a method of operating a multi-axis nut runner apparatus according to embodiments of the present disclosure.

### DETAILED DESCRIPTION

Advantages and features of the present disclosure and methods to achieve them will become apparent from exemplary embodiments described below in detail with reference to the accompanying drawings. However, the present disclosure is not limited to exemplary embodiments disclosed below, but will be implemented in various different forms. The exemplary embodiments of the present disclosure make a disclosure of the present disclosure thorough and are provided so that those skilled in the art can easily understand the scope of the present disclosure. Therefore, the present disclosure will be defined by the scope of the appended claims. Like reference numerals throughout the description denote like elements.

Hereinafter, the present disclosure will be described with reference to the accompanying drawings for describing a multi-axis nut runner apparatus according to exemplary embodiments of the present disclosure.

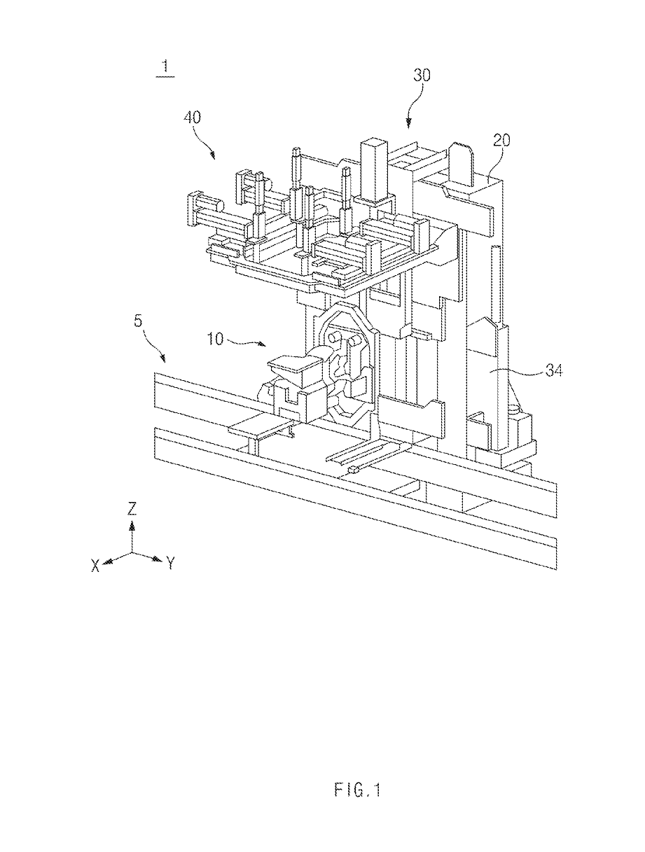

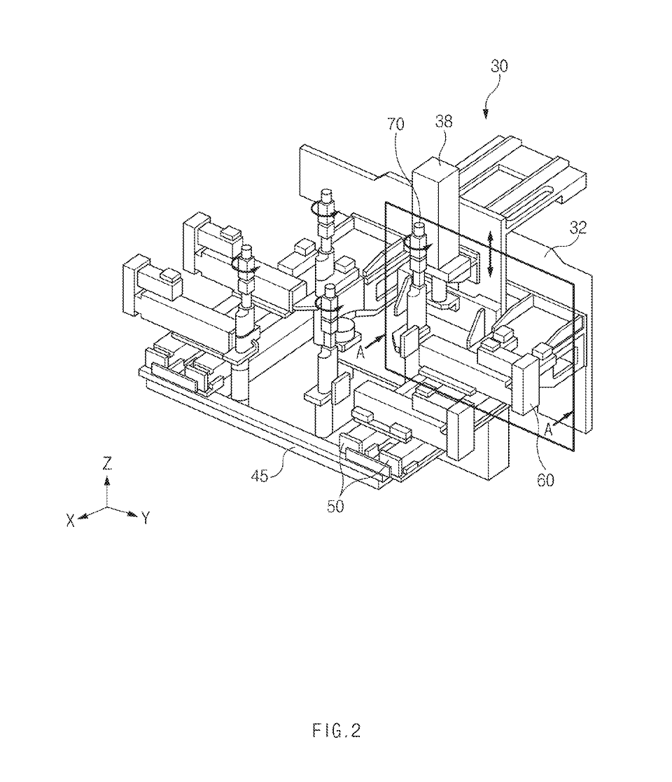

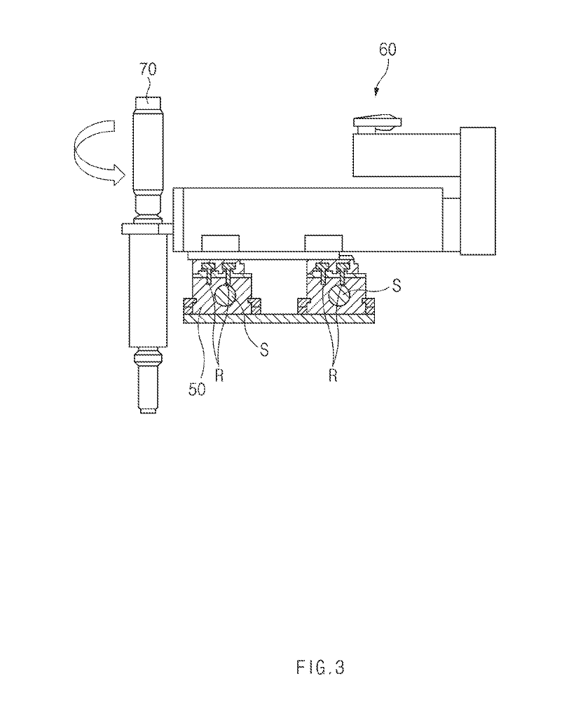

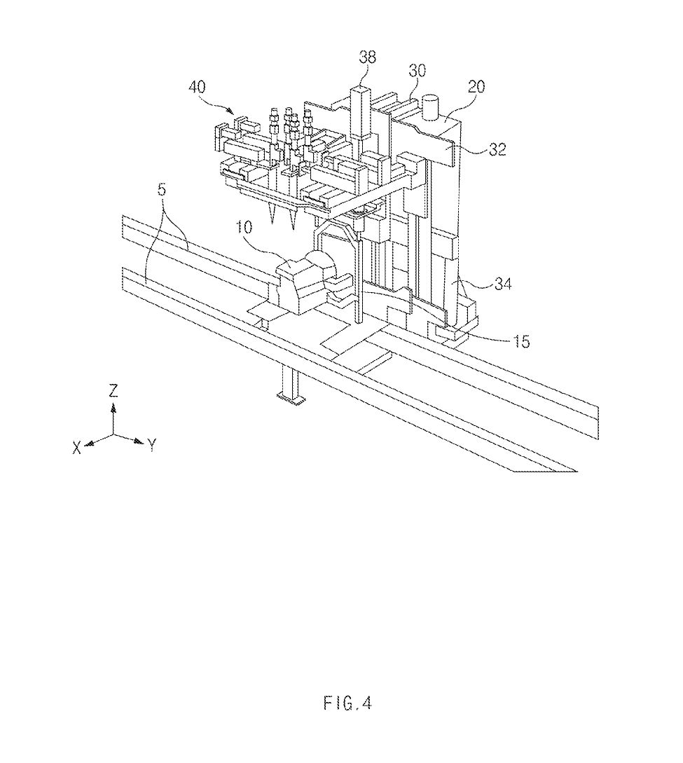

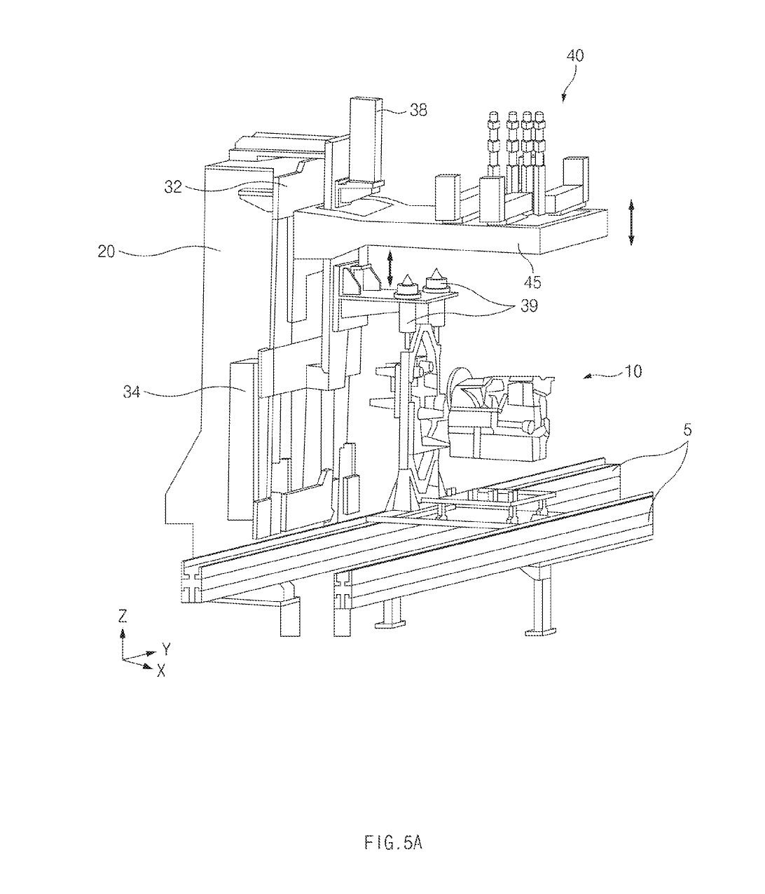

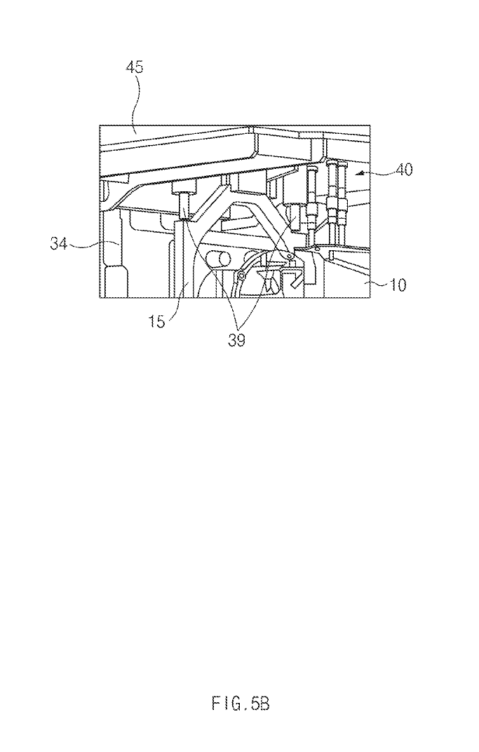

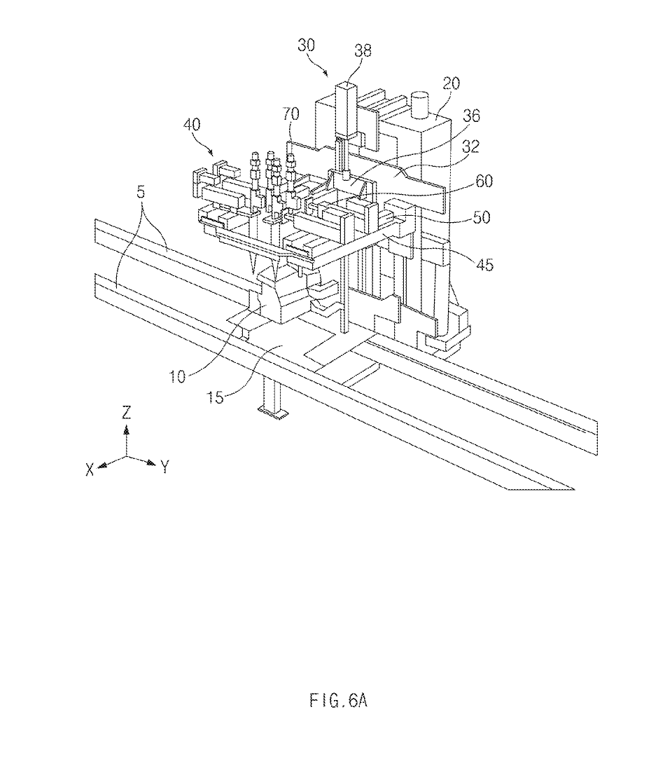

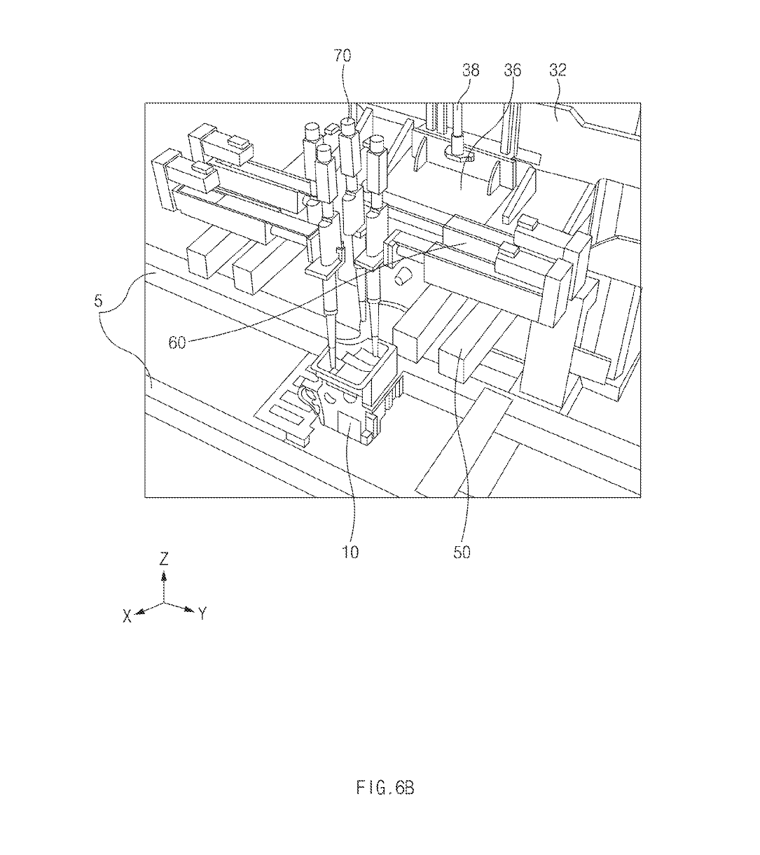

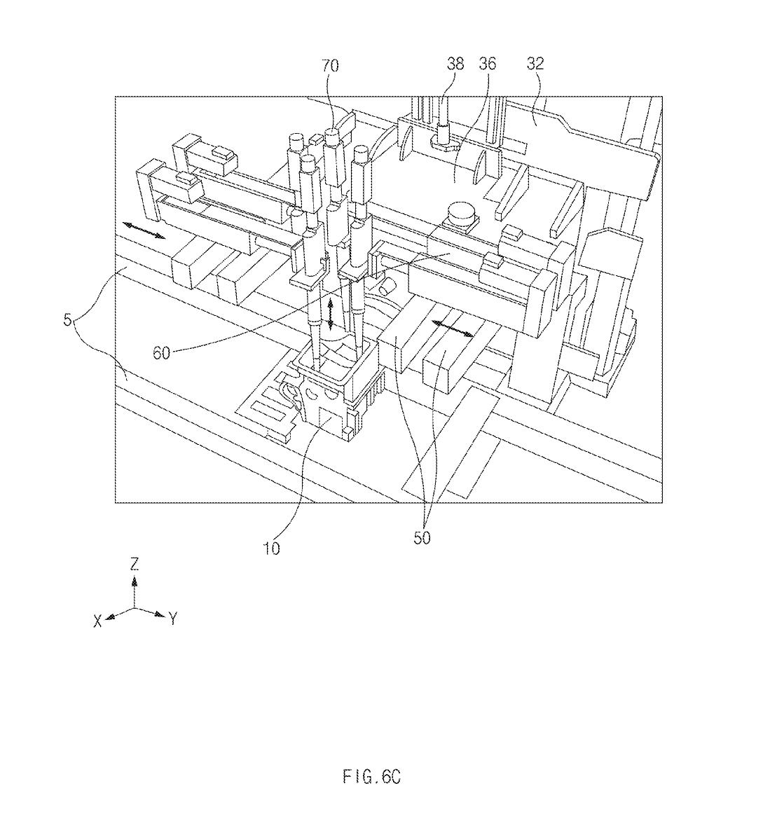

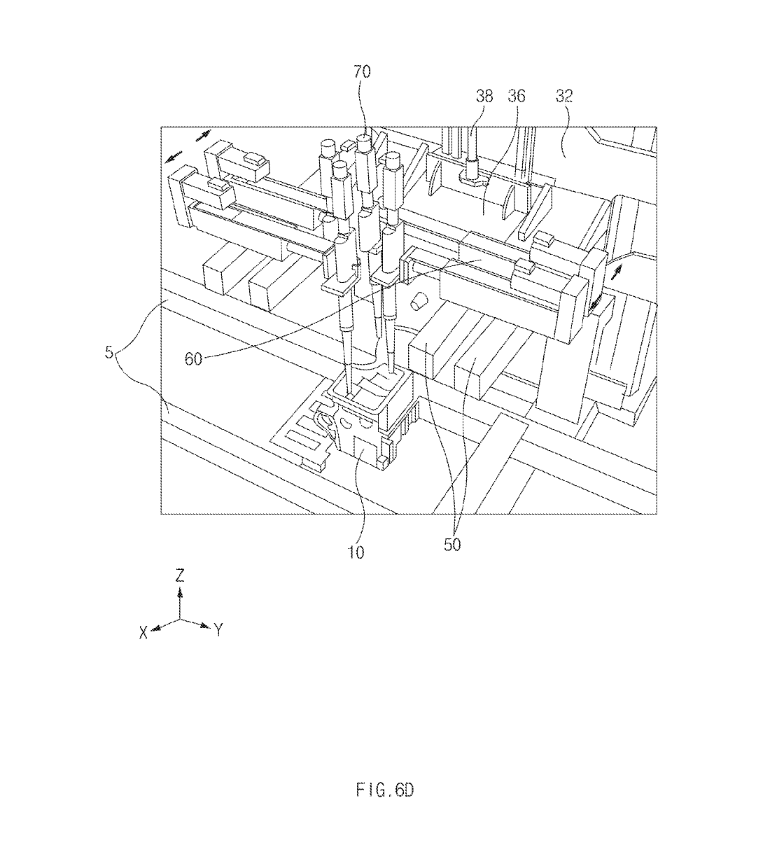

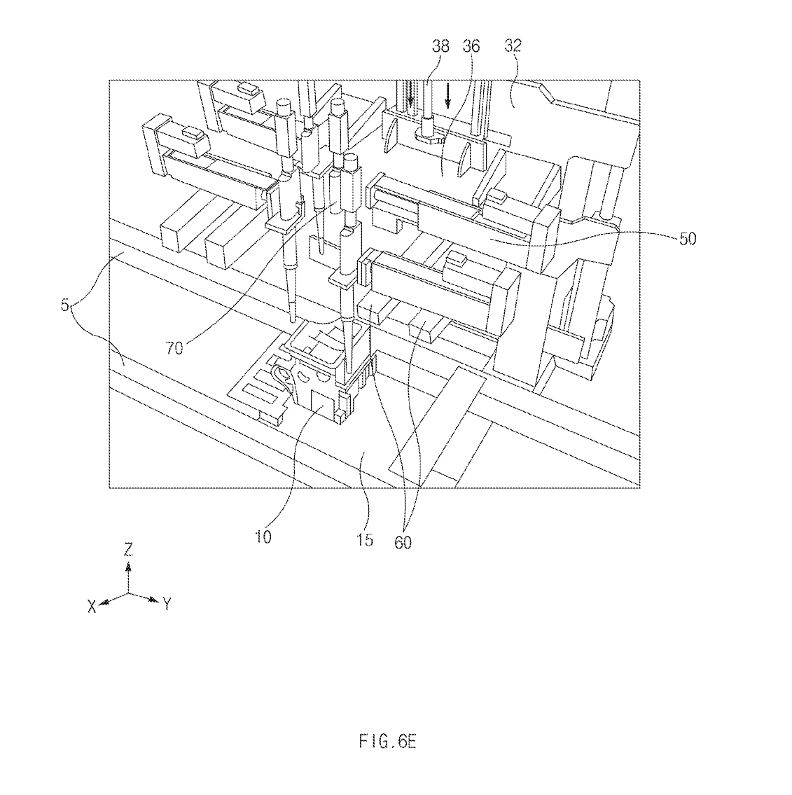

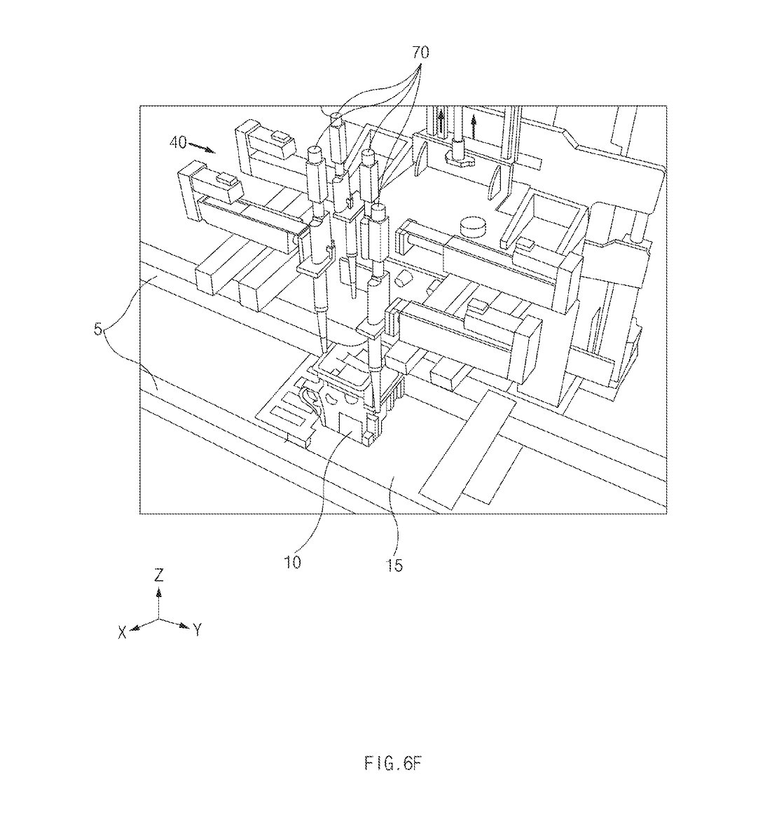

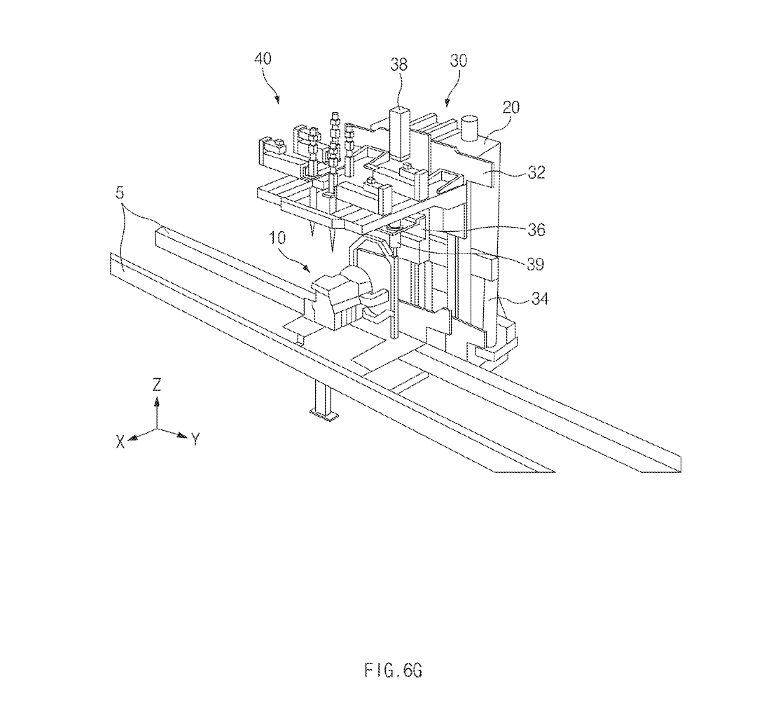

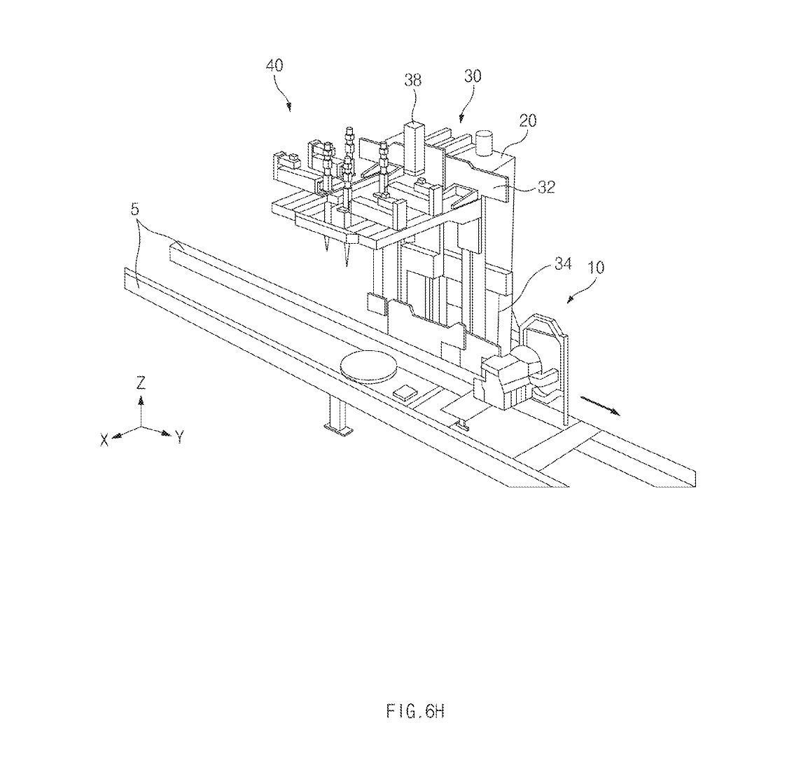

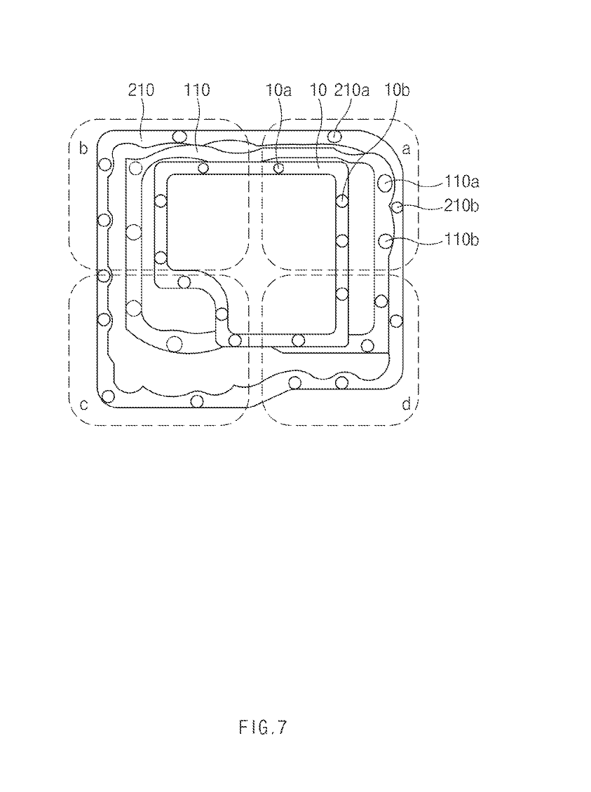

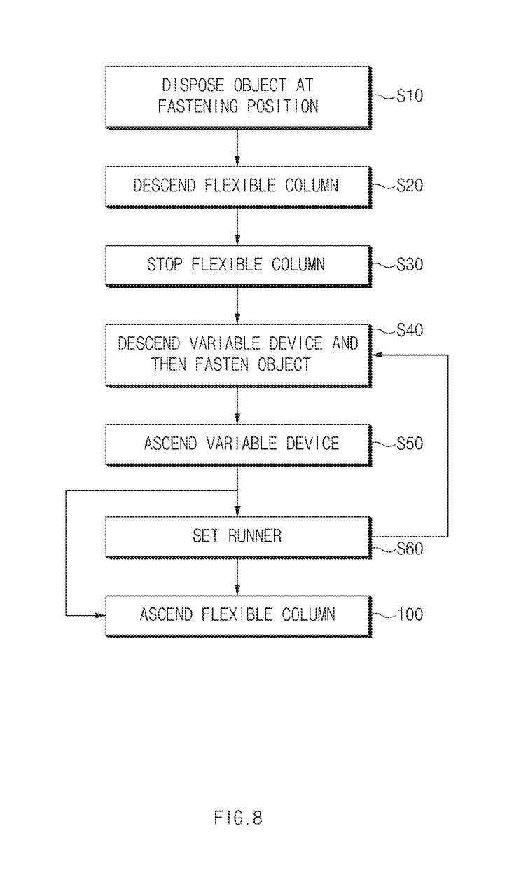

FIG. 1 is a perspective view illustrating a multi-axis nut runner apparatus according to embodiments of the present disclosure, FIG. 2 is a view illustrating a variable device of FIG. 1, FIG. 3 is a cross-sectional view taken along plane A-A of FIG. 2, FIGS. 4 and 5A and 5B are views illustrating a multi-axis nut runner apparatus and a fixing pin according to embodiments of the present disclosure, FIGS. 6A to 6H are perspective views illustrating an operation of a multi-axis nut runner apparatus according to embodiments of the present disclosure, FIG. 7 is a plan view illustrating objects having different sizes stacked on a pallet according to embodiments of the present disclosure, and FIG. 8 is a flowchart illustrating a method of operating a multi-axis nut runner apparatus according to embodiments of the present disclosure.

A multi-axis nut runner apparatus of a vehicle may be modified by those skilled in the art, and the present exemplary embodiment corresponds to a case of a multi-axis nut runner apparatus.

FIG. 1 is a perspective view illustrating a multi-axis nut runner apparatus according to embodiments of the present disclosure, FIG. 2 is a view illustrating a variable device of FIG. 1, FIG. 3 is a cross-sectional view taken along plane A-A of FIG. 2, and FIGS. 4 and 5A and 5B are views illustrating a multi-axis nut runner apparatus and a fixing pin according to embodiments of the present disclosure.

The multi-axis nut runner apparatus according to the present disclosure will be described with reference to FIGS. 1 to 5A and 5B. The multi-axis nut runner apparatus according to the present disclosure may include a base frame 20, a mounting frame 32 mounted on the base frame 20 to be vertically movable, a pallet 15 having an object disposed thereon and transferred along a transfer rail 5, and a variable device 40 installed on the mounting frame 32 and partitioned into a plurality of regions depending on a size of the object to be fastened.

The pallet 15 may have the object 10 disposed thereon, and may be transferred along the transfer rail 5. While the pallet 15 is moved along the transfer rail 5, the object 10 is disposed to coincide with a flexible column 30.

The flexible column 30 vertically descends and maintains a predetermined interval with the object 10. Here, the flexible column 30 is mounted on the mounting frame 32 mounted on the base frame 20 of the multi-axis nut runner apparatus 1. The mounting frame 32 may include a vertical control cylinder 34 that vertically moves the mounting frame from the base frame 20.

The flexible column 30 may include a support frame 36 mounted on the mounting frame 32. The support frame 36 may include a fixing pin 39 so as to maintain the predetermined interval with the object 10. The fixing pin 39 is formed on a support plate 30a formed to be perpendicular to the support frame 36, and is mounted on the support plate 30a. In addition, the support frame 36 has an electric cylinder 38 mounted thereon, so that the support plate 30a is moved in a vertical direction (a Z-axis direction).

Therefore, the mounting frame 32 of the flexible column 30 vertically descends by an operation of the vertical control cylinder 34 and the support plate 30a thereof is moved by an operation of the electric cylinder 38 at the same time, such that the fixing pin 39 is in contact with the pallet 15. In this case, the variable device 40 is in contact with the fixing pin 39 along the movement of the mounting frame 32. Therefore, even in the case in which the variable device 40 ascends for a fastening of a nut and a variation of a pitch, it is possible to maintain a degree of position with the pallet 15.

The variable device 40 may be installed on the mounting frame 32 and partitions the object 10 into a plurality of regions a, b, c and d as shown in FIG. 7 to thereby be fastened. The variable device 40 is fixed to a fixing plate 40a and is mounted on the mounting plate.

The variable device 40 may include a plurality of runners 42, 44, 46 and 48 so as to be each fastened to the object in the plurality of regions a, b, c and d. The plurality of runners may include a first runner 42, a second runner 44, a third runner 46 and a fourth runner 48 that each partition a portion of the plurality of regions a, b, c and d to thereby be fastened thereto.

Here, since the first runner 42, the second runner 44, the third runner 46 and the fourth runner 48 may have the same configuration, the first runner 42, which is one of the plurality of runners, will be described below by way of example.

The first runner 42 may include a first cylinder 50 moved in a direction crossing a movement direction of the object, a second cylinder 60 moved in a direction crossing the first cylinder 50 and mounted on the first cylinder 50 and a third cylinder 70 mounted on the second cylinder 60 and fastened to the object.

More particularly, the first cylinder 50 may be mounted on the fixing plate 40a so as to be moved in an x axis direction, and the second cylinder 60 may be mounted on the first cylinder 50 so as to be moved in a y axis direction. In this case, the first cylinder 50 includes a linear rail R connecting the first cylinder 50 and the second cylinder 60 to each other. In addition, the first cylinder 50 may include a ball screw S to axially move the first cylinder 50, and is movable in the x axis direction.

Here, the movements of the first cylinder 50 and the second cylinder 60 do not interfere with each other by the linear rail R. That is, the first cylinder 50 may be moved in the x axis direction on an axis of the ball screw S, and the second cylinder 60 may be moved in the y axis direction. Meanwhile, the x axis direction is a direction perpendicular to a movement direction of the object 10, the y axis direction is the same direction as the movement direction of the object 10, and the z axis direction is a vertical axis direction perpendicular to the x axis direction and the y axis direction.

Meanwhile, when the flexible column 30 is vertically moved in the z axis direction, the third cylinder 70 is mounted on the second cylinder 60 so as to be fastened to the object. Therefore, the first cylinder 50 and the second cylinder 60 are each moved in the x axis direction and the y axis direction, and the third cylinder 70 is fastened to the object by operating the first cylinder 50 and the second cylinder 60 to thereby vertically descend the flexible column 30 in the z axis direction at a position of a fastening point.

Meanwhile, referring to FIG. 7, the object is partitioned into a plurality of regions, that is, four regions, and the first runner 42 is fastened in a first region a, the second runner 44 is fastened in a second region b, the third runner 46 is fastened in a third region c and the fourth runner 48 is fastened in a fourth region d, respectively.

An operation of the multi-axis nut runner apparatus according to an exemplary embodiment of the present disclosure having the configuration as described above will be described.

FIGS. 6A to 6H are perspective views illustrating an operation of a multi-axis nut runner apparatus according to embodiments of the present disclosure, FIG. 7 is a plan view illustrating objects having different sizes and stacked on a pallet, and FIG. 8 is a flowchart illustrating a method of operating a multi-axis nut runner apparatus according to embodiments of the present disclosure.

The multi-axis nut runner apparatus according to the present disclosure will be described with reference to FIGS. 6A to 8. The object is stacked on the pallet and the pallet is moved along the transfer rail to be disposed below the variable device (S10). That is, after the object 10 is stacked on the pallet 15, the pallet 15 is disposed to be moved to the nut runner along the transfer rail.

Next, if the object 10 is disposed on the pallet 15, the flexible column 30 descends toward the object 10 by an operation of the vertical control cylinder 34 (S20). That is, the vertical control cylinder 34 is operated to allow the flexible column 30 to descend in a lower z axis direction in which the object 10 is present.

Next, the flexible column 30 may include the fixing pin 39, such that the fixing pin 39 is in contact with the pallet 15 when the flexible column 30 descends, and the flexible column 30 stops. The descending of the variable device 40 is limited by the fixing pin 39, thereby leaving a predetermined gap between the object 10 and the variable device 40. That is, the electric cylinder 38 is operated simultaneously with the vertical control cylinder 34, such that one side of the fixing pin 39 is in contact with the pallet. In this case, the fixing pin 39 is first in contact with the pallet 15, thereby making it possible to prevent the flexible column 30 from being excessively moved to the object 10, and to maintain a constant interval between the variable device 40 and the object 10.

Thereafter, the fixing plate 40a is in contact with the other side of the fixing pin 39. Therefore, the constant interval may be maintained between the variable device 40 and the object 10 by the fixing pin 39.

In addition, when the flexible column 30 stops (S30), and the variable device 40 descends, the plurality of runners 42, 44, 46 and 48 included in the variable device 40 are fastened to the object (S40). The first cylinder 50 and the second cylinder 60 perform a straight-line motion in each of the x axis direction and the y axis direction so that the variable device 40 is coincided with a first fastening point 10a of the object 10, thereby allowing the third cylinder 70 to be disposed over the first fastening point 10a. That is, when the object 10 is positioned below the flexible column 30, and the first cylinder 50 and the second cylinder 60 are moved in the x axis direction and the y axis direction, the third cylinder 70 is positioned over the first fastening point 10a. Then, the third cylinder 70 vertically descends in the z axis direction to thereby be fastened to the nut.

Next, after the variable device 40 ascends (S50) to be returned to an original position, the variable device 40 is moved along shafts of the plurality of cylinders included in the plurality of runners 42, 44, 46 and 48 so as to cross each other (S60). The flexible column 30 again vertically ascends to be returned to an original position. The first cylinder 50 and the second cylinder 60 are moved in the x axis direction and the y axis direction along a second fastening point 10b to allow the third cylinder 70 to be coincided with the second fastening point 10b. In addition, the flexible column 30 descends in the z axis direction, and the third cylinder 70 is fastened to the second fastening point 10b. In this case, the plurality of runners 42, 44, 46 and 48 are moved on the shafts of the plurality of cylinders in the regions partitioned so as not to interfere with each other.

Thereafter, after the flexible column 30 is fastened to the second fastening point 10b, the flexible column 30 again vertically ascends (100) to be returned to the original position.

Here, the case in which the objects are fastened depending on sizes of the objects will be described with reference to FIG. 7. Although the case in which a plurality of objects are stacked is described for convenience of explanation, only one of the respective objects is fastened to the nut runner apparatus. That is, only one of the plurality of objects is disposed on the pallet, so as to be fastened by the variable device. Meanwhile, fastening points 110a, 110b, 210a and 210b of a first object 110 and a second object 210 except for those illustrating the illustration of the present disclosure among the plurality of objects illustrating the objects being fastened to the first cylinder, the second cylinder and the third cylinder by the variable device according to the present disclosure.

More particularly, the first object 110 greater than the object 10 according to the present disclosure, and the second object 210 greater than the first object 110 are downwardly stacked in this order. The plurality of objects has a plurality of fastening points formed along a circumference thereof.

An upper side of the plurality of objects stacked as in FIG. 7 is partitioned into the first region a of a right side and the second region b of a left side, and a lower side of the plurality of objects is partitioned into the third region c of the left side and the fourth region d of the right side.

Here, referring to FIGS. 1 and 7, a plurality of runners are each controlled within the first region a, the second region b, the third region c and the fourth region d. That is, the first runner 42 is operated in the first region a, such that the object is fastened depending on the size thereof. The fastening in the first region a will be described by way of example. When the object 10 is disposed on the pallet 15, the first runner 42 is moved to be positioned on a vertical line with the first fastening point 10a on the shaft. Next, when the flexible column 30 descends, the third cylinder 70 is rotated and is fastened to the nut.

Thereafter, when the fastening is completed by the variable device 40, the flexible column 30 ascends to be returned to an original state, and the variable device 40 is again moved on the shaft to be coincided with the second fastening point 10b. In this case, since the variable device 40 is moved in the x axis direction and the y axis direction by the first cylinder 50 and the second cylinder 60, the fastening may be implemented regardless of the sizes of the objects. As a result, facilities do not need to be added or altered depending on models.

In addition, when the flexible column 30 again descends, the third cylinder 70 is rotated and is fastened to the nut, and the flexible column 30 is then returned to the original state.

Therefore, since the variable device 40 may move the size between the plurality of objects according to a value preset in a controller, the variable device 40 may be fastened to the respective fastening points 110a, 110b, 210a and 210b formed in the first object 110 and the second object 210 having different sizes according to a user selection.

As described above, according to the present disclosure, the multi-axis nut runner apparatus and the method of operating the multi-axis nut runner apparatus have one or more of the following effects.

First, in the multi-axis nut runner apparatus and the method of operating the multi-axis nut runner apparatus according to the present disclosure, since the nut runner apparatus is provided in a multi-axis, an area of the facilities may be reduced, and since the nut runner apparatus does not need to be replaced or altered even for a new model, costs may be reduced.

Second, in the multi-axis nut runner apparatus and the method of operating the multi-axis nut runner apparatus according to the present disclosure, flexibility of the facilities fastening the bolt is improved and secured, thereby making it possible to respond to a change of the model and to implement a sharing production of an engine of multiple models, that is, the sharing production of the engine of two to three models or more.

However, effects of the present disclosure are not limited to the effects described above, and other effects that are not described above may be clearly understood by those skilled in the art from the claims.

In the multi-axis nut runner apparatus and the method of operating the multi-axis nut runner apparatus according to an exemplary embodiment, the configuration and the method of the above-mentioned exemplary embodiments are not restrictively applied. That is, all or some of the respective exemplary embodiments may be selectively combined with each other so that they may be variously modified.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A multi-axis nut runner apparatus comprising:
a base frame;
a mounting frame mounted on the base frame to be vertically movable;
a pallet having an object disposed thereon and transferred along a transfer rail; and
a variable device installed on the mounting frame and partitioned into a plurality of regions depending on a size of the object to thereby be fastened.

2. The multi-axis nut runner apparatus according to claim 1, wherein the variable device includes a plurality of runners so as to be fastened to the object in the plurality of partitioned regions.

3. The multi-axis nut runner apparatus according to claim 2, wherein the plurality of runners includes a first runner, a second runner, a third runner and a fourth runner that each partition a portion of the plurality of regions to thereby be fastened thereto.

4. The multi-axis nut runner apparatus according to claim 2, wherein the plurality of runners includes:
a first cylinder moved in a direction crossing a movement direction of the object;
a second cylinder mounted on the first cylinder and moved in a direction crossing the first cylinder; and
a third cylinder mounted on the second cylinder and fastened to the object.

5. The multi-axis nut runner apparatus according to claim 4, wherein the first cylinder is installed with a linear rail allowing the second cylinder to be moved in the direction crossing the first cylinder.

6. The multi-axis nut runner apparatus according to claim 5, wherein the first cylinder includes a ball screw to axially move the first cylinder.

7. The multi-axis nut runner apparatus according to claim 1, further comprising a flexible column mounted on the mounting frame so as to maintain a predetermined interval between the variable device and the object.

8. The multi-axis nut runner apparatus according to claim 7, wherein the flexible column includes a fixing pin provided to secure a position of the object.

9. The multi-axis nut runner apparatus according to claim 8, wherein the flexible column has a support frame formed to fix the fixing pin, and further includes an electric cylinder vertically moving the support frame.

10. A method of operating a multi-axis nut runner apparatus, the method comprising:
an object being stacked on a pallet and the pallet being moved along a transfer rail to be disposed below a variable device;
when the object is disposed, a flexible column descending toward the object by an operation of a vertical control cylinder;
the flexible column including a fixing pin, such that the fixing pin is in contact with the pallet when the flexible column descends;
the flexible column stopping; and
when the flexible column stops, and the variable device descends, a plurality of runners included in the variable device being fastened to the object.

11. The method according to claim 10, wherein in the step of the plurality of runners included in the variable device being fastened to the object, the descending of the variable device is limited by the fixing pin, such that a predetermined gap is left between the object and the variable device.

12. The method according to claim 10, further comprising, after the plurality of runners included in the variable device are fastened to the object, the variable device ascending to be returned to an original position, and being then moved along shafts of a plurality of cylinders included in the plurality of runners to cross each other.

13. The method according to claim 12, wherein the plurality of runners are moved on the shafts of the plurality of cylinders in regions partitioned so as not to interfere with each other.
